(19) United States
(12) Patent Application Publication
(10) Pub. No.: US 2008/0162699 A1
(43) Pub. Date: Jul. 3, 2008

(54) Selectively Apportioning User Web Traffic

(76) Inventor: John Gaffney, La Jolla, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/965,694

(22) Filed: Dec. 27, 2007

Related U.S. Application Data
(60) Provisional application No. 60/882,864, filed on Dec. 29, 2006.

(51) Int. Cl. G06F 15/173

(52) U.S. Cl. 709/226

(57) ABSTRACT

A set of two or more web pages containing page elements with differing structures is provided. Thereafter, conversion metrics associated with each web page in the set are. User traffic is then automatically apportioned in the set such that those web pages in the set which perform better based on the monitored conversion metrics receive increasingly more traffic than the other web pages in the set. Related systems, apparatus, techniques, and articles are also described.

### RELATED APPLICATION

This application claims the priority of U.S. Pat. App. Ser. No. 60/882,864, filed on Dec. 29, 2006, the contents of which are hereby fully incorporated by reference.

### FIELD

The subject matter described herein relates to techniques and systems for selectively apportioning user web traffic between two or more web pages.

### BACKGROUND

The textual and graphical content of a web page directly influences the rate at which users will perform desired actions (such as clicking a link, filling out a form, etc.). Because it is difficult to predict specifically which page elements will have the most impact on the desired user action, some marketers perform comparison tests (“A/B” tests) in which the stream of incoming web page visitors is split between multiple pages, each of which presents some variation from a basic design. The performance of these pages is measured during the test, and the best-performing page is typically selected for long-term use.

A variety of techniques are used to create the page variants. The simplest approach is to create separate web pages, each with a specific combination of page elements, divide traffic among them, and measure the results. Another approach is to create a single web page with dynamic page elements which are displayed at specified frequencies, again measuring the results. Tests are generally performed for a predetermined period of time or number of page visits, after which the results are reviewed by one or more individuals, the winning page is selected, and that page is put into production.

Test creation and management is often complex. The marketer who wants to execute a test may be expected to understand advanced statistical concepts and possess webmaster skills and network access permissions.

In addition, time and money are often lost during the typical testing process due to the need for human evaluation of the results. Tests may continue to send visitors to underperforming pages well after sufficient data is available to determine a “winning” page or pages. The effect is exacerbated by the lack of human monitoring during non-business hours, particularly weekend and holidays. Visits are normally generated by advertising campaigns, with a measurable cost per visit, so any inefficiency in the test results in excess expenses.

In addition, because the pages are intended to be optimized to maximize a specific business result, such as leads or sales generated in subsequent pages, test inefficiencies also result in lost revenues. Also, because inexperienced marketing personnel may be assigned to create and/or monitor test results, these individuals may inadvertently select the wrong page as the “winner” based on misinterpretation of the test results, again leading to excess expenses and lost revenue. Finally, tests may be performed infrequently, leading to long periods in which visitor preferences may have changed and existing pages no longer encourage visitor actions at the desired rate.

### SUMMARY

In one aspect, a set of two or more web pages containing page elements with differing structures is provided. Thereafter, conversion metrics associated with each web page in the set are. User traffic is then automatically apportioned in the set such that those web pages in the set which perform better based on the monitored conversion metrics receive increasingly more traffic than the other web pages in the set.

There are many different variations which may be implemented depending on the desired criteria. For example, the automatic diversion of user traffic can occur after an expiration of a pre-defined time period and/or after a pre-defined number of page requests for at least one of the two web pages. The conversion rate can be based on conversion metrics for a pre-defined group of users, sources of user traffic, user behavior that resulted in the request for the web page, and the like. The user behavior can include, for example, keyword search terms, activated URL, activated advertisement, and previously traversed web page.

The conversion metrics can be based on performance criteria. The performance criteria can be, for example, activation of graphical user elements on the corresponding web page displaying additional visual media, adding content to the corresponding web page, initiating chat sessions via the corresponding web page, e-mailing the corresponding web page or a portion thereof, linking to the corresponding web page. The performance criteria can be based on marketing- and sales-related user actions such as clicking links to related pages, requesting additional information by submitting contact information, downloading information or products, or purchasing products. In addition, the performance criteria can be based on the count of the user actions (such as total sales events in subsequent pages), the value of the user actions (such as total sales revenue in subsequent pages), or the profit from the user actions (such as net revenue, after the cost of attracting users, if known, is subtracted from the total sales revenue). The performance criteria can further be based on user actions in monitored pages outside the test set, when such actions are performed subsequent to visiting a page in the test set and can thus be attributed back to that test page.

In some implementations, the automatically apportioning can comprise redirecting a web browser to a second URL corresponding to the second of the two web pages.

In an interrelated aspect, a request for a target URL including query string parameters is received. Thereafter, a test web page set is selected based on the query string parameters. Historical data for landing pages in the test web page set that comprises traffic splits among the landing pages is retrieved. User traffic is selectively delivered to at least two of the landing pages in the test web page set based on a desired traffic split among the landing pages using the historical data.

In a further interrelated aspect, a request for a target URL including query string parameters is received. A test web page set can then be selected based on the query string parameters. Historical data for content within landing pages in the test web page set that includes historical traffic splits among the content in the landing pages is received. Content within at least one landing page based on a desired conversion rate is selectively modified so that rendering of the landing pages can be initiated.

The subject matter described herein is directed to web page A/B testing techniques. In one variation, non-technical users are guided through test creation using a step-by-step process that presumes no knowledge of how A/B tests are created or managed. In another variation, the benefits of A/B testing are extended by continuously optimizing overall performance during the test.

In one variation, instructions in the form of software, hardware, firmware, or a combination of the three manage web page A/B tests. The instructions determine the degree to which each web page within a test set is able to elicit specific user actions under controlled conditions. The instructions create the test set and parameters, control the progress of the test, and report the results. The goal of such A/B testing is usually to identify those web pages that generate the highest performance with respect to a specific business goal, such as conversion to leads or sales.

Through the use of a step-by-step “wizard” approach, one variation makes it easy for non-technical marketing personnel to create and manage multiple tests.

In addition, through the use of an optimization technique, one variation reduces the likelihood of excess expense and lost revenue by continuously evaluating performance and automatically shifting more visitors to the highest-performing test pages. High-performing pages thus may receive the bulk of the traffic throughout the test, without human intervention. In addition, the test can be continued indefinitely, with new test pages added at any time to challenge the current best-performers.

This encourages marketers to continuously test new ideas, which is generally acknowledged as a marketing best practice, and can be expected to produce significantly improved business results over a longer period.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The details of the subject matter described herein, both as to its structure and operation, may be gleaned in part by study of the accompanying drawings, in which like reference numerals refer to like parts, and in which:

FIG. 1 is a process flow diagram illustrating method for diverting user traffic among web pages to obtain a desired conversion rate;

FIG. 2 is a block diagram illustrating an example interaction between components of a system configured for testing web pages according to a variation of the subject matter described herein.

FIG. 3 is a block diagram illustrating an example request and response flow between components of a system configured for testing web pages that results in a requesting browser being redirected to a desired landing page.

FIG. 4 is a block diagram illustrating an example request and response flow between components of a system configured for testing web pages that results in a landing page being dynamically generated.

### DETAILED DESCRIPTION

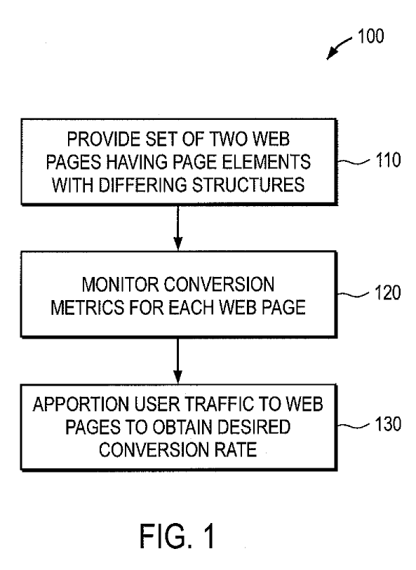

FIG. 1 is a process flow diagram illustrating a method 100, in which, at 110, a set of two or more web pages containing page elements with differing structures is provided. Thereafter, conversion metrics associated with each web page in the set are, at 120 monitored. User traffic is then, at 130, automatically apportioned in the set such that those web pages in the set which perform better based on the monitored conversion metrics receive increasingly more traffic than the other web pages in the set.

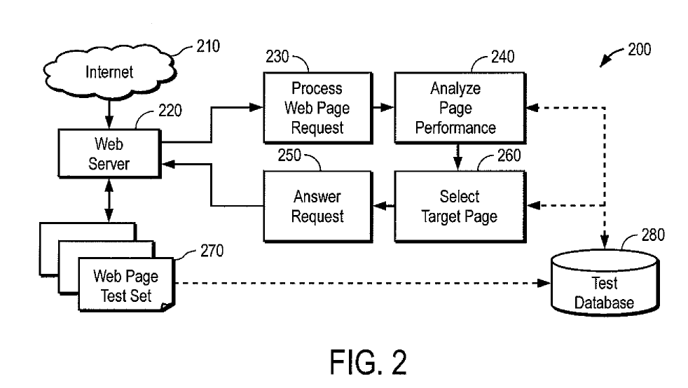

FIG. 2 is a diagram illustrating a system 200 for testing web pages in which a web server 210 is coupled to a testing database 280. The web server 220 is configured to receive requests via the Internet 210 for rendering a web page 230. After such a request 230 is received, page performance is analyzed 240 in order to determine which target page 260 to render in the remote browser. The request is answered 250 by having the web server 220 transmitting data via the Internet 210 to allow the selected target page to be rendered. The target page is obtained via a test database 280 which comprises a plurality of web page test sets 270 which can be selected and ultimately rendered at the remote browser.

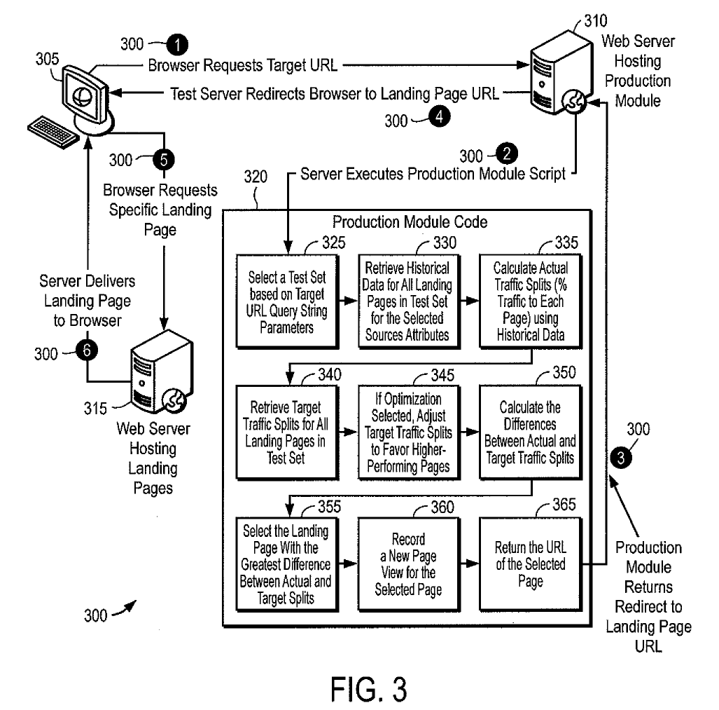

FIG. 3 is a diagram 300 illustrating a system in which, at 300-1, a client 305 requests a target URL from a first web server 310. Thereafter, the first web server 310, which is hosting a production module, at 300-2, executes production module script. The production module script includes production module code which, at 325, selects a test set based on target URL query string parameters (e.g., contextual information included in the URL such as customer ID, test set, etc.). Thereafter, at 330, historical data is retrieved for all landing pages in a corresponding test set for the selected source attributes. Traffic splits among each page are calculated, at 335, using historical data. Target traffic for all landing pages in a particular test set are, at 340, retrieved. Thereafter, if optimization is desired (e.g., conversion rate optimization), then target traffic splits are adjusted, at 345, to favor higher performing rates. Differences between actual and target traffic splits are, at 350, then calculated. The landing page with the greatest difference between actual and target splits is, at 355, selected so that, at 360, a new page view for the selected view can be recorded. Subsequently, at 365, the URL of the selected page can be returned. The production module, at 300-3, returns a redirect to the landing page URL so that the web server 310 can, at 300-4, redirect the browser at the client 305 to the landing page URL. Thereafter, at 300-5, the browser requests the specific landing page from a second web server 315 that hosts landing pages, which in turn at 300-6, delivers the landing page to the browser.

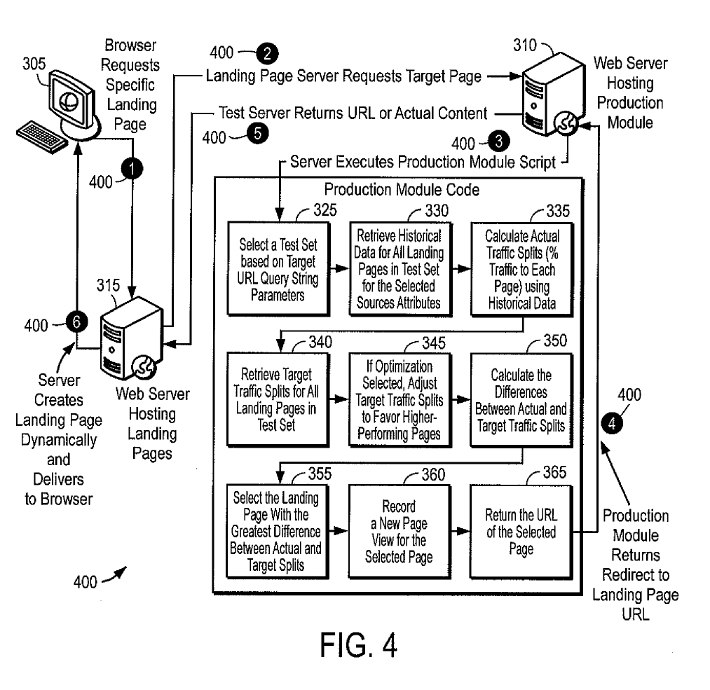

FIG. 4 is a diagram 400 illustrating a system related to that of FIG. 3 but which does not redirect the browser to a second URL. The browser of the client 305 requests, at 400-1 a specific landing page from the second web server 315. The second web server, at 400-2, requests a target page from the first web server 310. The first web server 310 then executes production module script such as that described in connection with FIG. 3, and at 400-4, the production module returns a redirect to the landing page URL. The first web server 310, at 400-5, returns a URL or actual content to be displayed in the landing page. The second web server 315 then, at 400-6, creates the landing page dynamically and delivers it to the browser of the client 305 without redirection.

The subject matter described herein is directed to web page A/B testing techniques. In one variation, non-technical users are guided through test creation using a step-by-step process that presumes no knowledge of how A/B tests are created or managed. In another variation, the benefits of A/B testing are extended by continuously optimizing overall performance during the test.

In one variation, instructions in the form of software, hardware, firmware, or a combination of the three manage web page A/B tests. The instructions determine the degree to which each web page within a test set is able to elicit specific user actions under controlled conditions. The instructions create the test set and parameters, control the progress of the test, and report the results. The goal of such A/B testing is usually to identify those web pages that generate the highest performance with respect to a specific business goal, such as conversion to leads or sales.

Through the use of a step-by-step “wizard” approach, one variation makes it easy for non-technical marketing personnel to create and manage multiple tests.

In addition, through the use of an optimization technique, one variation reduces the likelihood of excess expense and lost revenue by continuously evaluating performance and automatically shifting more visitors to the highest-performing test pages. High-performing pages thus may receive the bulk of the traffic throughout the test, without human intervention. In addition, the test can be continued indefinitely, with new test pages added at any time to challenge the current best-performers.

This encourages marketers to continuously test new ideas, which is generally acknowledged as a marketing best practice, and can be expected to produce significantly improved business results over a longer period.

The subject matter described herein may work in conjunction with an Internet web page server to perform a number of actions. In one variation, the system steps users through all of the actions necessary to create and manage web page A/B tests, including the entry of traffic allocation (“traffic split”) values for each page, the selection of optimization parameters, and the identification of sources of cost data for return-on-investment calculation during reporting. Another variation may maintain a database of web page sets, and their related control parameters, for which testing is desired (the “target pages”). Another variation may maintain a database of dynamic page elements and their variations which should be tested within a single physical page, with each combination of element variations treated as a separate “page” for purposes of the A/B test. This approach to A/B testing is also known as “multivariate testing”. Another variation may maintain a historical record of performance (the “performance measurements”) for each target page, which may be based on specific user actions (such as lead submissions or sales) that occur in subsequent visits to other pages in the web site.

Another variation may maintain a set of parameters that specify which performance measurements to optimize (the “performance criteria”). Another variation may accept requests from the web server for a selection from the target pages. Another variation may analyze the historical performance measurements for each target page. Another variation may choose the target page which best meets the performance criteria. Another variation may instruct the web server to display the selected target page. Another variation may display ad-hoc performance reports for each test, detailing for each test page the measured performance against key metrics during the selected date range.

One variation may include two independent software modules, a management module and a production module (the “modules”). The management module may provide user login and account management, and may allow users to create, update and delete web page test sets and view their real-time and historical performance. The production module may receive incoming web page requests and may fulfill them in real time from existing test sets. The production module may also receive incoming conversion event notification events and may record them in real time.

The modules may share a common database. The database may store information entered through the management system in a series of relational tables. It also may store real time information from the production system with links back to the related test sets.

The modules may be designed to run on a web server. The management module can be accessed via any Web browser. The production module may receive requests through information appended to a standard Web uniform resource locator (“URL”), and may respond either with a browser redirect (in the case of a page request) or by delivering a transparent image file (in the case of a conversion event notification).

One variation of the management module provides a series of screens that guide users through both the creation and the updating of test sets (the “wizard”). The wizard may present multiple screens that provide access to all test set attributes. Users can step through the wizard in sequence or jump directly to any previously-completed step.

A performance reports page may also be provided by a variation of the management module. The performance reports page may provide a real-time report display based on a selected date range. The performance reports page may also provide report export (e.g., in Microsoft Excel format) and printing and it may further permit real-time testing of the system, with options to record the test clicks as either live or test data.

A context-sensitive help system with detailed instructions on how to use each screen in the module may also be provided by a variation of the management module.

The management module may also provide a preferences screen that allows users to set up default pages which can replace test set pages in the event they become unavailable, and also may provide account login information so that real-time ad campaign data (e.g., Google) can be accessed during performance report generation.

A configuration changes screen may also be provided by a variation of the management module that displays an “audit trail,” for example by date, of all changes made to individual test sets.

Within the Management Module, the one variation of the wizard may provide a test naming screen. In the test naming screen, the user may enter a name and an optional description for the test. Another variation of the wizard may provide an adding landing page screen. In this screen, the user may enter one or more URLs and optional descriptions for the test set pages (the “landing pages”) to be tested. If requested, the screen can automatically test the landing pages to determine if the URLs are correct, and that the pages are being served without error. The results of the test may be immediately displayed next each URL.

Another variation of the wizard may provide a choosing a control page screen. In this screen, the user selects one of the landing pages as the “control page.” The control page may be the original, or default, page used to provide a baseline for measuring the performance of other landing pages in the test set. Also, in the event that any landing pages in the test set become unavailable, requests for that page may be fulfilled by the control page.

Another variation of the wizard may provide an adding a safety page screen. In this screen, the user may enter the URL of a “safety page”. In the event that all landing pages in the test set become unavailable (including the control page), page requests may be directed to the safety page.

Another variation of the wizard may provide a verifying landing page tags screen. If requested, this screen can automatically test each landing page in the test set to determine if the “landing page tag” is properly included in the page hyper-text meta language (“HTML”). The landing page tag may be required if the user wants to track the “conversion” of landing page views to future lead capture or sales activity. The results of the test may be immediately displayed next to each landing page name. The screen also may provide a complete description of how to add the landing page tag to landing pages.

Another variation of the wizard may provide a verifying conversion tags page. If requested, this screen can automatically test any web page to determine if the “conversion page tag” is properly included in the page HTML. The conversion page tag may be required if the user wants to track leads or sales conversions. The results of the test may be immediately displayed next to the tested URL. The screen also may provide a complete description of how to add the conversion page tag to a web page.

Another variation of the wizard may provide a specifying traffic split screen. In this screen, the user may specify the percentage of incoming page requests that should be directed to each of the landing pages in the test set. If requested, this screen can automatically split incoming page requests equally across all of the landing pages.

Another variation of the wizard may provide a tracking campaign costs screen. In this screen, the user can specify how the costs for the test are calculated. The user can choose not to track costs, or to provide one of the following, for example: a fixed cost for the entire test, an estimated cost per page view (cost per click), or the name of a Google AdWords campaign that should be accessed for cost data. (If provided, costs may be automatically allocated across the landing pages based on traffic received, and are displayed in the performance reports. If lead or sales conversion values were provided in the conversion tags, return on investment (“ROI”) may also be calculated and presented based on the campaign costs.)

Another variation of the wizard may provide an optimizing performance screen. In this screen, the user can choose whether to automatically optimize test performance. When enabled, optimization may automatically adjust the traffic split to direct more incoming page requests to those landing pages that achieve better performance for specific conversion metrics. The user can also choose the minimum time period and the minimum number of page requests that must occur between optimizations.

Optimization can be influenced by several types of metrics. A first type of metric is optional “upstream” information (the “source attributes”) that describes the user, the traffic source, and other information that might conceivably affect the test. These attributes include, but are not limited to: specific user behavior that resulted in the current page request (keyword searched for, link clicked, page previously viewed, etc.), records of historical behavior for the current user or behavioral groups in which the current user can be inferred to belong, actual or inferred user demographics and psychographics, and campaign data such as such as source web site, ad campaign, ad group, ad, keyword, etc. The currently available attributes may be displayed in a format that allows one or more to be selected for the test. If no attributes are selected, the optimization process may not take source attributes into account.

A second type of metric is the user actions for which test performance may be evaluated and optimized (the “performance criteria”). In one variation, the performance criteria may include “in page” actions such as clicking links or buttons that display additional text, images and videos within the page, adding comments to the page, initiating chat sessions with other from the page, emailing page content to others from within the page, posting a link to the page to blogs and online services and other user actions which increase the time spent on the page or the spread of the page and it's content to other users. In another variation the performance criteria may include “downstream” actions by the user on subsequent pages which can be tracked as metrics such as lead conversion rate (%), lead conversion monetary value, sales conversion rate (%), and sales conversion monetary value.

For example, in a case where source attributes are not specified and the performance criteria is lead conversion rate, the optimization process would send more visitors to pages which exhibit higher overall lead conversion rates, regardless of source attributes. In the previous example, if a source attribute of “ad” had been selected, the optimization process would determine, for each ad which resulted in incoming visitors, which pages exhibit higher lead conversion rates for that ad, and send visitors from that ad to those pages.

Another variation of the wizard may provide a target URL screen. In this screen, the user can get the URL which should be used for all incoming page requests to the test set. (When clicked, the target URL may invoke the production module and may provide the information the module needs to determine which test set is being requested. The production module then may select one of the landing pages from the specified test set, and redirects the user's web browser to the selected page).

Another variation of the wizard may provide test activation screen. In the screen, the user can activate or inactivate the test. If inactive, all page requests to the test are fulfilled using the safety page.

In response to incoming page requests, the production module may store the source attributes of the request. The production module may then select a landing page and may redirect the user's web browser to that page, or instruct the landing page server itself to deliver specific content, using a number of criteria. If optimization is enabled for the current test set the production module may determine how much time has elapsed since the last optimization of the current set for the selected source attributes, and how many pages in the set have been targeted during that time. If both the elapsed time and the number of clicks exceed the values entered by the user during test setup, optimization proceeds. For each page in the set, the production module may retrieve historical performance data corresponding to the selected source attributes and performance metric. The production module then may calculate a performance average for each page. The average may be skewed toward the historical performance of that page based on the value of a “historical weighting” variable. This weighting process may help to damp out the effects of short-lived “spikes” in page performance which do not reflect long-term performance. The weighting factor is adjustable.

The production module then may calculate a new traffic split percentage by totaling the performance averages for all pages in the set, and then assigning new traffic percentages to each page based on the ration of that page's performance average to the total. The production module then may “boost” the degree to which better performing pages are allocated traffic by applying an exponential weighting to the traffic split that favors the better performers. The exponential weighting factor is adjustable.

During the above steps, the production module may limit traffic reallocation so that pages cannot individually fall below a preset traffic minimum and cannot exceed a preset traffic maximum. The minimum and maximum values are adjustable. The production modules may assign the new traffic split percentages to the target pages. Finally, the production module may use the adjusted traffic split values to select which target page should be served next.

If optimization is not enabled, the production module may use the traffic split values most recently entered by the user to select which target page should be served next.

Regardless of whether optimization is enabled, the production module may use traffic split percentages to determine which landing page should be served next by: calculating the actual percentage of set traffic received by each page in the set since the traffic split was last adjusted, determining the difference between the actual percentage and the desired traffic split for each target page, and selecting the target page for which there is the greatest difference.

One optimization algorithm that can be used in connection with the current subject matter is described below. An array of historical metrics can be retrieved for the pages in the current test set. Two averages can be calculated for each page, the average of the metrics during a specified window of time prior to and including the last optimization, and the average of the recent metrics accumulated since the last optimization.

The two averages can then be combined proportionally based on the value of a “historical weighting” variable, as follows:

CombinedAverage=(HistoricalAverage*HistoricalWeighting)+RecentAverage*(1−HistoricalWeighting))

The resulting combined averages can be sorted in descending order. They can then be exponentially compressed based on the value of an “performance dampening” variable, which decreases the metrics value for pages with lower values, with the rate of dampening increasing at lower values. The operation can be performed in a manner similar to:

DampenedAverage=(e**(PerformanceDampener*(CurrentMetric/Maximum Metric))−1)/(e**PerformanceDampener−1)

The resulting values can then be normalized so that their sum equals 100. These values then become the target traffic percentage for the pages in the test set.

The target values can be further modified by interpolating between the current traffic percentage and the target percentage using an “optimization rate” variable, which controls how quickly the optimization process occurs:

NewTrafficPercentage=(TargetPercentage*OptimizationRate)+(ExistingPercentage*(1−OptimizationRate))

Finally, minimum and maximum limits can be applied to the percentages, renormalization can be performed to ensure traffic percentages total 100 percent, and the existing traffic split percentage of each page can be adjusted proportionally using the new values.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method comprising:
providing a set of two or more web pages containing page elements with differing structures;
monitoring conversion metrics associated with each web page in the set; and
automatically apportioning user traffic in the set such that those web pages in the set which perform better based on the monitored conversion metrics receive increasingly more traffic than the other web pages in the set.

2. A computer-implemented method as in claim 1, wherein the user traffic is apportioned using an optimization algorithm.

3. A computer-implemented method as in claim 1, further comprising: reporting conversion metrics for at least one of the web pages in the set.

4. A computer-implemented method as in claim 1, wherein the apportioning is based on pre-defined percentages.

5. A computer-implemented method as in claim 1, wherein the monitoring comprises monitoring conversion metrics associated with at least one page element on each web page.

6. A computer-implemented method as in claim 1, wherein the monitoring comprises monitoring conversion metrics for a web page external to the set that is linked to a web page in the set.

7. A computer-implemented method as in claim 1, wherein automatic reapportionment of user traffic occurs after an expiration of a pre-defined time period.

8. A computer-implemented method as in claim 1, wherein automatic reapportionment of user traffic occurs after a pre-defined number of page requests for at least one of the two web pages in the set.

9. A computer-implemented method as in claim 1, wherein the conversion rate is based on conversion metrics for a pre-defined group of users.

10. A computer-implemented method as in claim 1, wherein the conversion rate is based on conversion metrics for sources of user traffic.

11. A computer-implemented method as in claim 1, wherein the conversion metrics are based on user behavior that resulted in the request for the web page.

12. A computer-implemented method as in claim 11, wherein the user behavior comprises an action selected from a group comprising: keyword search terms, activated URL, activated advertisement, and previously traversed web page.

13. A computer-implemented method as in claim 1, wherein the conversion metrics are based on performance criteria.

14. A computer-implemented method as in claim 13, wherein the performance criteria are selected from a group comprising: activation of graphical user elements on the corresponding web page displaying additional visual media, adding content to the corresponding web page, initiating chat sessions via the corresponding web page, e-mailing the corresponding web page or a portion thereof, linking to the corresponding web page.

15. A computer-implemented method as in claim 14, wherein the performance criteria are based on marketing- and sales-related user actions selected from a group comprising: clicking links to related pages, requesting additional information by submitting contact information, downloading information or products, or purchasing products.

16. A computer-implemented method as in claim 15, wherein the performance criteria are based on: a count of the user actions, total sales events in subsequent pages, a value of the user actions, total sales revenue in subsequent pages, profit from the user actions, net revenue subtracted from total sales revenue.

17. A computer-implemented method as in claim 13, wherein the performance criteria are based on user actions in monitored pages outside the test set, when such actions are performed subsequent to visiting a page in the test set and can thus be attributed back to that test page.

18. A computer-implemented method as in claim 1, wherein the automatically apportioning comprises redirecting a web browser to a second URL corresponding to the second of the two web pages.

19. An article comprising a tangible machine-readable medium embodying instructions that when performed by one or more machines result in operations comprising:
providing a set of two or more web pages containing page elements with differing structures;
monitoring conversion metrics associated with each web page in the set; and
automatically apportioning user traffic in the set such that those web pages in the set which perform better based on the monitored conversion metrics receive increasingly more traffic than the other web pages in the set.

20. A computer-implemented method comprising:
receiving a request for a target URL including query string parameters;
selecting a test web page set based on the query string parameters;
retrieving historical data for landing pages in the test web page set, the historical data comprising traffic splits among the landing pages; and
selectively apportioning user traffic to at least two of the landing pages in the test web page set based on a desired traffic split among the landing pages using the historical data.

21. A computer-implemented method comprising:
receiving a request for a target URL including query string parameters;
selecting a test web page set based on the query string parameters;
retrieving historical data for content within landing pages in the test web page set, the historical data comprising historical traffic splits among the content in the landing pages; and
selectively modifying content within at least one landing page based on a desired conversion rate; and
initiating rendering of the landing pages.
